(19) United States
(12) Patent Application Publication
(10) Pub. No.: US 2025/0123899 A1
(43) Pub. Date: Apr. 17, 2025

(54) System and Method for Autoscaling Flexible Cloud Namespace Instances in a Cloud Computing Environment

(71) Applicant: VMware LLC, Palo Alto, CA (US)

(72) Inventors: AMITA VASUDEV KAMAT, Palo Alto, CA (US); PIYUSH HASMUKH PARMAR, Pune (IN); DHAVAL SHAH, Bangalore (IN); PAWAN SAXENA, Palo Alto, CA (US)

(21) Appl. No.: 18/607,315

(22) Filed: Mar. 15, 2024

(30) Foreign Application Priority Data
Oct. 11, 2023 (IN) 202341068292

(51) Int. Cl. G06F 9/50

(52) U.S. Cl. CPC G06F 9/5072; G06F 9/505

(57) ABSTRACT

System and method for scaling flexible cloud namespaces (FCNs) in a software-defined data center (SDDC) uses resource utilizations in resource capacity profiles of the FCNs in the SDDC, which are compared with resource utilization thresholds set for the resource capacity profiles. Based on these comparisons, resource capacities in the resource capacity profiles of the FCNs are scaled.

### CROSS-REFERENCES

This application claims the benefit of Indian Patent Application number 202341068292, entitled “SYSTEM AND METHOD FOR AUTOSCALING FLEXIBLE CLOUD NAMESPACE INSTANCES IN A CLOUD COMPUTING ENVIRONMENT,” filed on Oct. 11, 2023, of which is hereby incorporated by reference in its entirety.

### BACKGROUND

Current cloud infrastructure-as-a-service offerings are typically built around the notion of purchasing hardware infrastructure in the unit of hosts (i.e., bare metal instances) from public cloud providers and installing virtualization software on top of the hardware infrastructure. These cloud offerings typically require customers to directly interact with underlying infrastructure for all of their consumption needs. However, this model has many drawbacks. For example, a cloud system usually requires customers to purchase a minimum of two hosts, which may not be cost effective for many entry level public cloud customers or customers with a smaller resource requirement. In addition, customers typically have to deal with the complexity of underlying management solutions for running their applications on the cloud infrastructure. Further, customers generally need to participate in all life cycle management (LCM), which is a complex operation. Lastly, capacity planning is typically performed in terms of number of hosts, which is sub-optimal for most customers and use cases.

Moreover, in typical public cloud infrastructure offerings, the topmost pain point for customers may be cloud instance flexibility. For example, customers deploy their applications on certain type of public cloud instances based on their initial requirement analysis of their applications. However, deploying applications on certain type of public cloud instances is not flexible as customers may experience migration costs and downtime to address End Of Life (EOL) for the current instance type and/or to utilize a better suited instance type available to lower cost or to satisfy changing workload requirement.

### SUMMARY

System and method for scaling flexible cloud namespaces (FCNs) in a software-defined data center (SDDC) uses resource utilizations in resource capacity profiles of the FCNs in the SDDC, which are compared with resource utilization thresholds set for the resource capacity profiles. Based on these comparisons, resource capacities in the resource capacity profiles of the FCNs are scaled.

A computer-implemented method for scaling flexible cloud namespaces (FCNs) in a software-defined data center (SDDC) in accordance with an embodiment of the invention comprises monitoring resource utilizations in resource capacity profiles of the FCNs in the SDDC, comparing the resource utilizations in the resource capacity profiles with resource utilization thresholds set for the resource capacity profiles, and scaling resource capacities in the resource capacity profiles of the FCNs based on comparisons of the resource utilizations for the resource capacity profiles with resource utilization thresholds set for the resource capacity profiles. In some embodiments, the steps of this method are performed when program instructions contained in a computer-readable storage medium are executed by one or more processors.

A system in accordance with an embodiment of the invention comprises memory and at least one processor configured to monitor resource utilizations in resource capacity profiles of flexible cloud namespaces (FCNs) in a software-defined data center (SDDC), compare the resource utilizations in the resource capacity profiles with resource utilization thresholds set for the resource capacity profiles, and scale resource capacities in the resource capacity profiles of the FCNs based on comparisons of the resource utilizations for the resource capacity profiles with resource utilization thresholds set for the resource capacity profiles.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a computing system in accordance with an embodiment of the invention.

FIG. 2 illustrates an example of flexible cloud namespaces (FCNs) in the computing system in accordance with an embodiment of the invention.

FIG. 3 shows components and elements of the computing system, which are involved in the FCN autoscaling operations, as layers in accordance with an embodiment of the invention.

FIG. 4 is a flow diagram of a process of automatically scaling an FCN in a software-defined data center (SDDC) in the computing system in accordance with an embodiment of the invention.

FIG. 5 is a flow diagram of a computer-implemented method for scaling FCNs in a software-defined data center (SDDC) in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

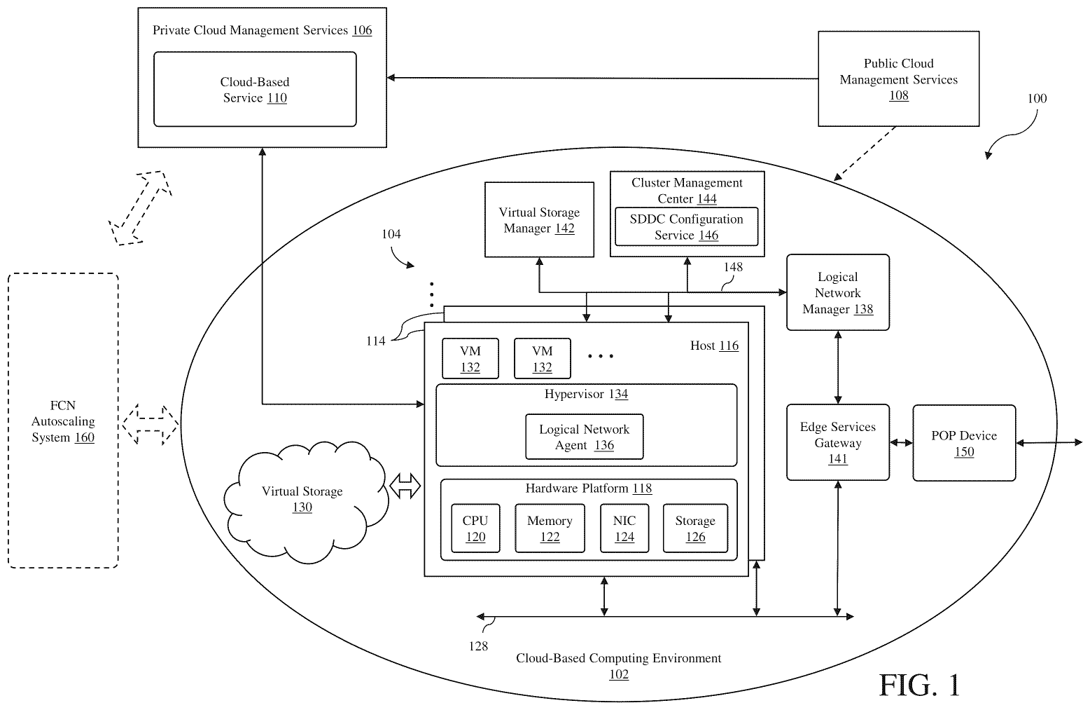

Turning now to FIG. 1, a computing system 100 in accordance with an embodiment of the invention is illustrated. The computing system 100 includes a cloud-based computing environment 102 in which a software-defined data center (SDDC) 104 is deployed. As an example, the cloud-based computing environment 102 may be a virtual private cloud (VPC) in a public cloud environment, for example, a VMware Cloud™ in an AWS public cloud. However, in other embodiments, the SDDC 104 can be configured as any software-defined computing network.

As shown in FIG. 1, the computing system 100 further includes a private cloud management service 106, which resides in the public cloud environment outside of the cloud-based computing environment 102. The private cloud management service 106 provides various services for administrators to create and manage cloud-based computing environments, such as the cloud-based computing environment 102, in the public cloud environment. In addition, the private cloud management service 106 provides services for the administrators to create SDDCs, such as the SDDC 104, in the cloud-based computing environments. As part of some of these services, the private cloud management services 106 may communicate with public cloud management services 108, which manage the public cloud environment in which the cloud-based computing environments are created. As an example, the public cloud management services 108 can provide hardware and/or software needed to create, maintain, update and/or delete the cloud-based computing environments in the public cloud environment.

The services provided by the private cloud management services 106 may be requested by the administrators using a graphic user interface (GUI), which may be provided by a web-based application or by an application running on a computer system that can access the private cloud management services 106. In some situations, some of these services may be requested by an automated process running in the private cloud management services 106 or on a computer system that can access the private cloud management services 106.

As illustrated, the private cloud management services 106 include at least a cloud-based service 110. The cloud-based service 110 provides back-end services for the cloud-based computing environments, such as deploying new SDDCs in the cloud-based computing environments and restoring one or more management components in the SDDCs.

As shown in FIG. 1, the SDDC 104 includes a cluster 114 of host computers (“hosts”) 116. The hosts 116 may be constructed on a server grade hardware platform 118, such as an x86 architecture platform, which may be provided by the public cloud management services 108. As shown, the hardware platform 118 of each host 116 may include conventional components of a computer, such as one or more processors (e.g., CPUs) 120, system memory 122, a network interface 124, and storage 126. The processor 120 can be any type of a processor commonly used in servers. In some embodiments, the memory 122 is volatile memory used for retrieving programs and processing data. The memory 122 may include, for example, one or more random access memory (RAM) modules. The network interface 124 enables the host 116 to communicate with other devices that are inside or outside of the cloud-based computing environment 102 via a communication network, such as a network 128. The network interface 124 may be one or more network adapters, also referred to as network interface cards (NICs). The storage 126 represents one or more local storage devices (e.g., one or more hard disks, flash memory modules, solid state disks and/or optical disks), which are used as part of a virtual storage 130 (e.g., virtual storage area network (SAN)), which is described in more detail below. In this disclosure, the virtual storage 130 will be described as being a virtual SAN, although embodiments of the invention described herein are not limited to virtual SANs.

Each host 116 may be configured to provide a virtualization layer that abstracts processor, memory, storage and networking resources of the hardware platform 118 into virtual computing instances (VCIs) 132 that run concurrently on the same host. As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the invention described herein are not limited to virtual machines (VMs).

In the illustrated embodiment, the VCIs in the form of VMs 132 are provided by host virtualization software 134, which is referred to herein as a hypervisor, which enables sharing of the hardware resources of the host by the VMs. One example of the hypervisor 134 that may be used in an embodiment described herein is a VMware ESXi™ hypervisor provided as part of the VMware vSphere® solution made commercially available from VMware, Inc. The hypervisor 134 may run on top of the operating system of the host or directly on hardware components of the host. For other types of VCIs, the host may include other virtualization software platforms to support those VCIs, such as Docker virtualization platform to support “containers”. Although embodiments of the inventions may involve other types of VCIs, various embodiments of the invention are described herein as involving VMs.

In the illustrated embodiment, the hypervisor 134 includes a logical network (LN) agent 136, which operates to provide logical networking capabilities, also referred to as “software-defined networking”. Each logical network may include software managed and implemented network services, such as bridging, L3 routing, L2 switching, network address translation (NAT), and firewall capabilities, to support one or more logical overlay networks in the cloud-based computing environment 102. The logical network agent 136 may receive configuration information from a logical network manager 138 (which may include a control plane cluster) and, based on this information, populates forwarding, firewall and/or other action tables for dropping or directing packets between the VMs 132 in the host 116, other VMs on other hosts, and/or other devices outside of the cloud-based computing environment 102. Collectively, the logical network agent 136, together with other logical network agents on other hosts, according to their forwarding/routing tables, implement isolated overlay networks that can connect arbitrarily selected VMs with each other. Each VM may be arbitrarily assigned a particular logical network in a manner that decouples the overlay network topology from the underlying physical network. Generally, this is achieved by encapsulating packets at a source host and decapsulating packets at a destination host so that VMs on the source and destination can communicate without regard to the underlying physical network topology. In a particular implementation, the logical network agent 136 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols, such as stateless transport tunneling (STT), Network Virtualization using Generic Routing Encapsulation (NVGRE), or Geneve, instead of, or in addition to, VXLAN.

The hypervisor 134 may also include a local scheduler and a high availability (HA) agent, which are not illustrated. The local scheduler operates as a part of a resource scheduling system that provides load balancing among enabled hosts 116 in the cluster 114. The HA agent operates as a part of a high availability system that provides high availability of select VMs running on the hosts 116 in the cluster 114 by monitoring the hosts, and in the event of a host failure, the VMs on the failed host are restarted on alternate hosts in the cluster.

As noted above, the SDDC 104 also includes the logical network manager 138 (which may include a control plane cluster), which operates with the logical network agents 136 in the hosts 116 to manage and control logical overlay networks in the SDDC. In some embodiments, the SDDC 104 may include multiple logical network managers that provide the logical overlay networks of the SDDC. Logical overlay networks comprise logical network devices and connections that are mapped to physical networking resources, e.g., switches and routers, in a manner analogous to the manner in which other physical resources as compute and storage are virtualized. In an embodiment, the logical network manager 138 has access to information regarding physical components and logical overlay network components in the SDDC 104. With the physical and logical overlay network information, the logical network manager 138 is able to map logical network configurations to the physical network components that convey, route, and filter physical traffic in the SDDC 104. In a particular implementation, the logical network manager 138 is a VMware NSX® Manager™ product running on any computer, such as one of the hosts 116 or VMs 132 in the SDDC 104. The logical overlay networks of the SDDC 104 may sometimes be simply referred to herein as the “logical network” of the SDDC 104.

The SDDC 104 also includes one or more edge services gateway 141 to control network traffic into and out of the SDDC. In a particular implementation, the edge services gateway 141 is VMware NSX® Edge™ product made available from VMware, Inc. running on any computer, such as one of the hosts 116 or VMs 132 in the SDDC 104. The logical network manager(s) 138 and the edge services gateway(s) 141 are part of a logical network platform, which supports the software-defined networking in the SDDC 104.

In the illustrated embodiment, the SDDC 104 includes a virtual storage manager 142, which manages the virtual SAN 130. As noted above, the virtual SAN 130 leverages local storage resources of host computers 116, which are part of the logically defined cluster 114 of hosts that is managed by a cluster management center 144 in the computing system 100. The virtual SAN 130 allows the local storage resources of the hosts 116 to be aggregated to form a shared pool of storage resources, which allows the hosts 116, including any VMs running on the hosts, to use the shared storage resources. The virtual SAN 130 may be used to store any data, including virtual disks of the VMs. In an embodiment, the virtual storage manager 142 is a computer program that resides and executes in a computer system, such as one of the hosts 116, or in one of the VMs 132 running on the hosts 116.

The SDDC 104 also includes the cluster management center 144, which operates to manage and monitor the cluster 114 of hosts 116. The cluster management center 144 may be configured to allow an administrator to create a cluster of hosts, add hosts to the cluster, delete hosts from the cluster and delete the cluster. The cluster management center 144 may further be configured to monitor the current configurations of the hosts 116 in the cluster 114 and the VMs running on the hosts. The monitored configurations may include hardware and/or software configurations of each of the hosts 116. The monitored configurations may also include VM hosting information, i.e., which VMs are hosted or running on which hosts. In order to manage the hosts 116 and the VMs 132 in the cluster, the cluster management center 144 supports or executes various operations. As an example, the cluster management center 144 may be configured to perform resource management operations for the cluster 114, including VM placement operations for initial placement of VMs and load balancing.

In an embodiment, the cluster management center 144 is a computer program that resides and executes in a computer system, such as one of the hosts 116, or in one of the VMs 132 running on the hosts 116. One example of the cluster management center 144 is the VMware vCenter Server® product made available from VMware, Inc.

As shown in FIG. 1, the cluster management center 144 includes an SDDC configuration service 146, which operates to configure one or more management components of the SDDC 104 (e.g., the logical network manager 138, the edge services gateway 141, the virtual storage manager 142 and/or the cluster management center 144), as described in detail below.

In the illustrated embodiment, the management components of the SDDC 104, such as the logical network manager 138, the edge services gateway 141, the virtual storage manager 142 and the cluster management center 144, communicate using a management network 148, which may be separate from the network 128, which are used by the hosts 116 and the VMs 132 on the hosts. In an embodiment, at least some of the management components or entities of the SDDC 104 may be implemented in one or more virtual computing instance, e.g., VMs 132, running in the SDDC 104. In some embodiments, there may be multiple instances of the logical network manager 138 and the edge services gateway 141 that are deployed in multiple VMs running in the computing system 100. In a particular implementation, the virtual storage manager 142 may be incorporated or integrated into the cluster management center 144. Thus, in this implementation, the cluster management center 144 would also perform tasks of the virtual storage manager 142.

In the illustrated embodiment, the SDDC 104 further includes a point-of-presence (POP) device 150, which acts as a bastion host to validate connections to various components in the SDDC 104, such as the logical network manager 138 and the cluster management center 144. Thus, the POP device 150 ensures that only trusted connections are made to the various components in the SDDC 104.

As noted above, current cloud offerings are typically built around the notion of purchasing hardware infrastructure in the unit of hosts (i.e., bare metal instances) from public cloud providers and installing virtualization software on top of the hardware infrastructure to form a newly created SDDC. These cloud offerings usually require customers to directly interact with underlying infrastructure for all of their consumption needs, which introduces many issues. As an example, there may be minimum purchase requirements that may not be cost effective for some public cloud customers, such as entry level public cloud customers or customers with small resource requirements. Customer may also have to address with the complexity of underlying management solutions, such as those provided by the logical network manager 138, the virtual storage manager 142 and the cluster management center 144, for running their applications on the cloud SDDC. In addition, customers may need to handle all life cycle management (LCM) operations and other operational processes, as explained above.

Unlike conventional cloud infrastructure as a service solutions of purchasing hardware infrastructure in the unit of hosts from public cloud providers and installing virtualization software on top of the hardware infrastructure, which require customers to directly interact with underlying infrastructure for their consumption needs, the cloud solution (also referred to herein as flexible cloud namespace (FCN)) in accordance with embodiments of the invention allows customers to purchase cloud computing capacity in small increments, which reduces the cost of entry into cloud computing, e.g., VMware Cloud™ on AWS, made commercially available from VMware, Inc of Palo Alto, California. Consequently, the cloud solution in accordance with embodiments of the invention can make cloud computing, e.g., VMware Cloud™ on AWS, an easy choice for direct DevOps consumption, deploying modern applications, virtual desktop infrastructure (VDI), traditional VM user with multi-tier workloads and other hybrid use cases. In addition, the cloud solution in accordance with embodiments of the invention allows customers to be shielded from underlying cloud instance type changes as the customers can purchase cloud infrastructure in terms units of resources. Additionally, the cloud solution in accordance with embodiments of the invention can enable instance migration with minimum or zero impact to customer workloads. In summary, the cloud solution (i.e., FCN) in accordance with embodiments of the invention can break the barrier of current host-based consumption model and create an illusion of elastic capacity for cloud customers. The cloud solution in accordance with embodiments of the invention can offer a multi-tenant solution for virtual computing instances (VCIs), such as VMs and containers, that is scalable and directly consumable via using a known interface, such as VMware Cloud console and Cloud Consumption Interface (CCI). The cloud solution in accordance with embodiments of the invention uses an internal fleet of existing cloud managed SDDCs and provides a consumption surface to allow purchasing portions of SDDC capacity (or a slice of SDDC) for workload consumptions, as explained in detail below. In some embodiments, at no point, customers are expected to directly interact with the SDDC management entities, such as the logical network manager 138, the virtual storage manager 142 and the cluster management center 144, to perform any management operations with respect to their FCNs. In other words, there is no awareness of underlying infrastructure for customers, and thus, no responsibilities with respect to the management components that provide the underlying infrastructures.

In accordance with an embodiment of the invention, using the cloud-based service 110, the public cloud management services 108, and/or the SDDC configuration service 146, in response to a first instruction from a customer, a computing infrastructure as a service is provided by creating a FCN in the SDDC 104, where the FCN includes a logical construct with resources in the SDDC, and in response to a second instruction from the customer, virtual computing instances (VCIs), such as VMs, are deployed in the FCN such that the VCIs execute in the FCN of the SDDC using the resources that are supported by the SDDC management components, such as the logical network manager 138, the virtual storage manager 142 and the cluster management center 144, which are not managed by the customer, but by the provider of the FCN. Multiple customers or tenants can create multiple FCNs on the same SDDC in which isolation is provided in terms of compute, storage and networking between the customers or tenants. In some embodiments, in response to an instruction from a second customer, a second flexible cloud namespace is created in the SDDC, where the second flexible cloud namespace includes a second logical construct with resources in the SDDC that are isolated from the resources of the logical construct of the FCN of the customer.

In some embodiments, the resources of the FCN include compute and storage resources in the SDDC 104. Using the cloud-based service 110, the public cloud management services 108, and/or the SDDC configuration service 146, based on the first instruction from the customer, capacity profiles (CPs) may be created to represent compute and storage resource capacity of the FCN. These CPs may include compute profiles and storage profiles. Thus, in some embodiments, using the cloud-based service 110, the public cloud management services 108, and/or the SDDC configuration service 146, based on the first instruction from the customer, a compute profile is created to represent the compute capacity of the FCN, and a storage profile is created to represent the storage capacity of the FCN. In some embodiments, the compute profile includes a configuration of virtual processors and memory. The compute profile may be one of a general purpose compute profile, a memory optimized compute profile or a compute optimized compute profile. In some embodiments, the storage profile includes a configuration of storage throughput and storage capacity. The storage profile may be associated with a specific a performance tier.

In some embodiments, the resources of the FCN further include networking resources in the SDDC 104. Thus, in some embodiments, using the cloud-based service 110, the public cloud management services 108, and/or the SDDC configuration service 146, based on the first instruction from the customer, a network configuration for the FCN is generated. The network configuration for the FCN may include least one of a network Classless Inter-Domain Routing (CIDR) configuration, a network segment configuration, a firewall configuration, an elastic IP address (EIP) configuration, a virtual private network (VPN) configuration, and a Network Address Translation (NAT) rule.

In some embodiments, using the cloud-based service 110, the public cloud management services 108, and/or the SDDC configuration service 146, based on the first instruction from the customer, a resource pool is created in the cloud-based computing environment 102. In addition, based on the first instruction from the customer, storage setup and/or network configuration setup are performed in the cloud-based computing environment 102.

The FCN cloud solution in accordance with embodiments of the invention may be a VMware Cloud™ service that provides compute capacity that can be sized and purchased according to workload needs based on VMware vSphere® technology. The FCN cloud solution can enable users to spin up a small virtual pool of resources (e.g., virtual CPU (vCPU), memory, and storage) on an isolated network and elastically extend based on application needs. The FCN cloud solution provides customers the ability to provision and scale workload VMs without the need to provision and manage the underlying VMware Cloud™ SDDC, such as VMware NSX®, VMware ESXi™, VMware vCenter® and other management software. The FCN cloud solution offers a new granular, flexible consumption model where customers can get the same speed, agility, built-in elasticity, and enterprise grade capabilities of VMware Cloud™ on AWS, but in smaller consumable units.

Instead of buying a minimum of two hosts, using the FCN cloud solution in accordance with embodiments of the invention, customers can buy slices of compute, storage and networking capacity as required by their workloads in the form of FCNs, thereby reducing the onboarding cost and allowing their FCNs to grow as per workload demands. For example, in a typical cloud system, a customer can purchase a 2-node SDDC in which one host is used for high availability (HA) and the other host is used for management VM reservations. Consequently, customers do not have a lot of capacity left to deploy their workloads as management VM reservations can take up to 32 vCPUs or more (depending on instance type) which cannot be used for workload VMs. Using the FCN cloud solution, customers do not have access to management VMs and they purchase capacity only for their workload VMs. Consequently, customers get to utilize 100% purchased capacity for their workloads. Because customers do not have to pay for management VMs, the FCN cloud solution is more cost effective and economically viable for entry level customers who have a small number of workloads with which to start. In addition, using the FCN cloud solution, customers do not have to manage the underlying hardware and networking configurations and can get their workloads up and running via VMware Console User Interface by providing minimal details. Further, instead of requiring customers to choose between different instance types, necessitating lengthy and detailed capacity and cost analysis, with limited flexibility to change instance types as needs change, the cloud solution allows customers to determine the best suited hardware for their workloads and take care of moving the workloads to a new hardware or new instance type to meet the workload requirements without customer intervention, which saves customers time, effort and migration costs, thus providing better customer experience. Using the FCN cloud solution, customer workloads can be moved to a new host using migration technology, such as VMware vSphere® vMotion® technology, with zero downtime, for example, when a host has reached end of life and is scheduled for retirement, when one or more hardware failures occur on a host, or when a better instance type is determined for a workload. When customers have their workloads up and running in their own environment, on premise or cloud, a hybrid management technology, such as VMware HCX technology, can be leveraged to seamlessly migrate workloads from customer environments to FCNs. In addition, using the FCN cloud solution, customers can improve operational efficiency by provisioning and scaling the FCNs and having comprehensive, enterprise grade infrastructure stack up and running in minutes, as compared to hours needed to provision a full SDDC. Further, using the FCN cloud solution, customers can onboard with purchasing limited capacity as needed for their workloads and can grow and shrink their cloud solution as per application needs. Additionally, customers do not have to monitor workload demands because this solution automatically scales up the FCN as per underlying workload demands, which reduces any administration and operational overheads from customers. Scaling-out or scaling-in an FCN can be much faster compared to the SDDC elasticity where an entire host has to be added or removed. In addition, using the FCN cloud solution, SDDCs in an FCN fleet can use the same SDDC bundle and can be upgraded similar to a VMware cloud fleet. Consequently, a maintenance schedule with FCN customers whose FCN instances are deployed across FCN SDDCs is not needed. Each customer may be informed in advance about the upcoming maintenance window of FCN SDDC hosting their FCN instances.

In some embodiments, an FCN is a logical consumption construct with compute, storage and networking resources in place to allow deploying production grade applications within a tenant selected region without any knowledge about underlying hardware and software infrastructure. FCNs provide a cost-effective way to supplement workload capacity without purchasing complete hosts. An FCN may span multiple fault domains and hardware types and is elastic in nature. An FCN can be used to deploy modern applications, multi-tier applications and any traditional workloads.

In some embodiments, an FCN provides multi-tenancy with compute, network and storage isolation. While different customers might be using the same underlying SDDC to run their workloads, an FCN network provides complete isolation for workloads running inside an FCN from other customers' workloads in another FCN. In some embodiments, networking solution for an FCN provides customers the capability to connect to their managed virtual private cloud(s) and on-premise data centers using a virtual private network (VPN), connect to their workloads running inside an FCN using Secure Shell (SSH), connect to the Internet from their workloads in an FCN, assign a public Internet Protocol (IP) to their workloads in an FCN, and/or connect to workloads within the same FCN. Networking configurations may be performed for each FCN to achieve isolation. Resources/configurations, such as, network Classless Inter-Domain Routing (CIDR), list of named network segments, network policies, firewall rules, Elastic IP (EIP) configurations, VPN configurations, and Network Address Translation (NAT) rules can be used.

In some embodiments, an FCN includes a collection of capacity profiles (CPs). A CP may define characteristics or requirements of workloads. Customers can create multiple CPs suitable for their workloads within an FCN. Each CP corresponds to the amount of capacity in terms of CPU, memory and storage that can be allocated from an underlying host cluster(s) having all hosts of a cloud supported instance type. A CP may be a collection of compute profiles and storage profiles. In some embodiments, compute profiles provide special CPU and memory characteristics as required by certain types of workloads and are categorized into types of a general purpose profile, a memory-optimized profile and a compute-optimized profile. General purpose profile is capacity backed by a hardware type that provides a simple balance of CPU and memory, which may be best suited for general production array of workload types. General purpose profile may be mostly suitable to run small to medium servers, databases and applications. Memory-optimized profile is capacity backed by a hardware type that provides a higher memory to CPU ratio than for the general purpose profile. Memory-optimized profile may be best for workloads requirements, such, as caching, high churn databases, in-memory analytics and the ability to help avoid swapping to disk. Compute-optimized profile is capacity backed by a hardware type that provides a higher CPU to memory ratio than for the general purpose profile. Compute-optimized profile may be suitable for workloads with high compute needs. In some embodiments, storage profiles provide special storage characteristics as required by certain types of workloads. A default general-purpose profile may come with a t-shirt sized (e.g., small, medium and large) performance tier and a scalable storage capacity. Workloads running in each CP within an FCN may consume storage from the collection of storage profiles associated with the FCN.

In some embodiments, each FCN has a default storage profile backed by a dedicated file system that exposes a network file system (NFS) datastore which is associated with every CP in the FCN. The presence of file system and datastore may not be visible to consumer of FCNs. Storage can be consumed independent of compute. Workloads running in each CP within an FCN consume storage from the collection of storage profiles associated with the FCN.

In some embodiments, using the cloud-based service 110, the public cloud management services 108, and/or the SDDC configuration service 146, customers or users can add and remove resources (CPU/memory/storage/network bandwidth etc.) to their FCN instances, e.g., in terms of FCN units, each of which has predefined resources, With this approach, if there are workloads demanding more resources than available capacity, then the performance of the workloads is impacted until the administrator adds more resources to the capacity profiles (CPs) created for the FCNs. If the resources under CPs are nearly full and workloads within the FCNs are demanding more capacity, then administrators need to add more resources to the CP's, migrate/power-off workloads, or customize individual workload resource allocations (e.g., reservations, shares, and limits). However, it is challenging and often impractical to do these manual customizations at-scale or in case of dynamic workloads.

Thus, the computing system 100 includes a flexible cloud namespace (FCN) autoscaling system 160, which provides a resource monitoring and elasticity platform that will automatically scale resources on CPs of FCNs based on workload/application demands. With elasticity policies created at the CP level, the FCN autoscaling system provides customers with knobs to define the autoscaling behavior for their FCNs. Thus, the FCN autoscaling system allows users to strike a balance between cost-effectiveness and availability/performance. One of the main advantages of the FCN autoscaling system is that the FCN autoscaling system provides dynamic resource allocation to customers CPs based on their workload demand patterns without requiring any reconfiguration of their existing workload configurations. In an embodiment, the FCN autoscaling system may leverage existing public cloud features, such as VMware's vMotion and distributed resource management capabilities, to provide autoscaling without customer workload reconfiguration, power cycling or downtime.

CPs in an FCN instance are basically resource pools carved out on SDDC clusters with compute capacity set as FCN and/or memory reservations on the resource pool. Also, storage capacity may be carved out as network file system (NFS) datastores mounted on the underlying hosts per FCN instance. In an embodiment, the FCN autoscaling system 160 leverages performance agents, such as VMware vSphere performance agents, to monitor CPU/memory and storage consumption (demand) on the CPs. These per-CP demand metrics, which are normalized using an elastic weighted moving average (EWMA) solution, are periodically monitored across all CPs.

The FCN autoscaling system 160 provides elasticity policies for customers to configure at a per CP level, both compute and storage, in an FCN so that the customers can control the autoscaling behavior of their FCN. In an embodiment, autoscaling operation executed by the FCN autoscaling system is in terms of FCN units for compute CP but in terms of storage units for storage CP. Thus, an FCN unit is a discrete amount of compute and memory for a CP. An overarching elasticity policy summary object at the FCN level may be provided to the customers describing the autoscaling behavior of its storage and compute CP components. In addition, elastic polices at individual compute and storage CP level may be provided for the customers to override different thresholds for CPU, memory and/or storage for monitoring and autoscaling individual CP of an FCN. In an embodiment, autoscaling minimum and/or maximum may be defined for the customers to set in terms of steps of FCN units, e.g., 2, 4, 6, etc. for compute CP.

The elasticity policy for an FCN includes elasticity policies for compute and storage CPs. In an embodiment, an elasticity policy is created for each unique compute CP within an FCN. This policy keeps track on the following parameters:
maxCpuThreshold—EWMA above which CPU based scale out kicks in
minCpuThreshold—EWMA for CPU scale in
maxMemoryThreshold—EWMA above which memory-based scale out kicks in
minMemoryThreshold—EWMA for memory scale in
scaleIncrement—increment/decrement FCN units when consumption breaches thresholds
maxLimit—max FCN unit limit
minLimit—min FCN unit limit

In an embodiment, an elasticity policy is also created for each unique storage CP within an FCN. This policy keeps track on the following parameters:
maxStorageThreshold—EWMA above which storage-based scale out kicks in
minStorageThreshold—EWMA for storage scale in
scaleIncrement—storage increment/decrement when datastore consumption breaches thresholds
maxLimit—max storage limit
minLimit—min storage limit

Based on the periodic resource monitoring at CPs in FCNs and customer set elasticity policies, a recommendation engine of the FCN autoscaling system 160 generates autoscaling recommendations on the CPs. Once such scale-up and scale-down recommendations are generated, the recommendation engine also computes the amount of FCN units and/or storage to be autoscaled as part of the recommendations based on the FCN/storage step size chosen by the customer, which are constrained by the min/max policy chosen by the customer. These recommendations are then acted upon by a cloud provider service to autoscale the CPs by updating the CPU and/or memory reservations of the resource pools (i.e., CPs). As a result, elasticity is achieved without workload reconfigurations.

In an embodiment, each CP is made of FCN units of different configuration as described in the following table.

| Capacity Profile | vCPU | Memory (GiB) | Storage (GiB) |
|---|---|---|---|
| General Purpose | 2 | 8 | 128 |
| Memory Optimized | 1 | 16 | 128 |
| Storage Optimized | 2 | 8 | 256 |
| Compute | 4 | 8 | 128 |
| Optimized | | | |

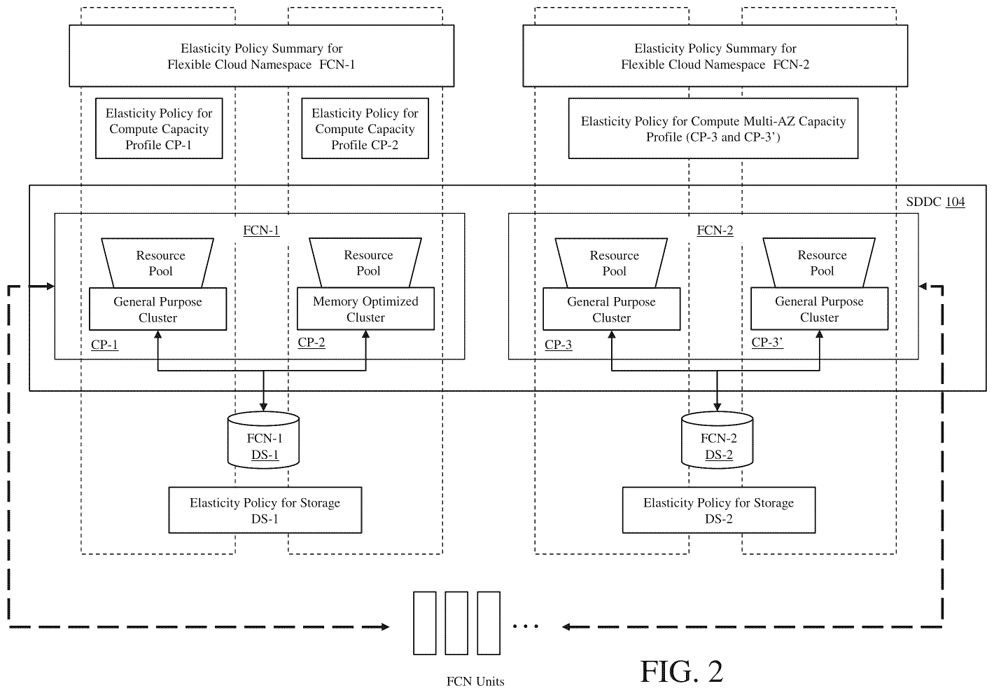

FIG. 2 illustrates an example of flexible cloud namespaces in the computing system 100 in accordance with an embodiment of the invention. In this example, there are two flexible cloud namespaces FCN-1 and FCN-2. The flexible cloud namespace FCN-1 includes a single Availability Zone (AZ) general purpose capacity profile CP-1, which may be supported by a resource pool from a general purpose cluster in the SDDC 104 in an availability zone AZ-1, and a single AZ memory optimized capacity profile CP-2, which may be supported by a resource pool from a memory optimized cluster in the SDDC 104 in the availability zone AZ-1. The FCN autoscaling system 160 maintains an elasticity policy for the capacity profile CP-1 and an elastic policy for the capacity profile CP-2. The storage for the flexible cloud namespace FCN-1 is a datastore DS-1, which may be provided by an external storage server instance, such as an Amazon FSx server instance. The FCN autoscaling system further maintains an elasticity policy for the datastore DS-1. In addition, the FCN autoscaling system maintains an elasticity policy summary for the flexible cloud namespace FCN-1, which includes the elastic policies for the capacity profile CP-1, the capacity profile CP-2 and the datastore DS-1.

The FCN-2 includes a multi-AZ compute CP, which is comprised of a first general purpose capacity profile CP-3, which may be supported by a resource pool from a general purpose cluster in the SDDC in the availability zone AZ-1, and a second general purpose capacity profile CP-3′, which may be supported by a resource pool from a general purpose cluster in the SDDC in a different availability zone AZ-2. The FCN autoscaling system 160 maintains an elasticity policy for the multi-AZ compute CP. The storage for the flexible cloud namespace FCN-2 is a datastore DS-2, which may be provided by the same or different external storage server instance as the datastore DS-1. The FCN autoscaling system further maintains an elasticity policy for the datastore DS-2. In addition, the FCN autoscaling system maintains an elasticity policy summary for the flexible cloud namespace FCN-2, which includes the elastic policies for the multi-AZ compute CP and the datastore DS-2.

Using the elastic policies for the different capacity profiles CP-1, CP-2, CP-3 and CP-3′ and the datastores DS-1 and DS-2, as well as the threshold values, these capacity profiles and datastores can be automatically scaled by the FCN autoscaling system 160 in terms of FCN units and storage units, as described below.

In an embodiment, isolation for different flexible cloud namespaces may be achieved using routers. For example, each of the flexible cloud namespaces FCN-1 and FCN-2 may be connected to a tier-1 logical router. These tier-1 logical routers are then connected to a tier-0 logical router, which can route data to the flexible cloud namespaces FCN-1 and FCN-2 via the respective tier-1 logical routers. Thus, the tier-0 logical router is a top-tier router that provides connections between the flexible cloud namespaces FCN-1 and FCN-2 and between each of the flexible cloud namespaces FCN-1 and FCN-2 to any external network.

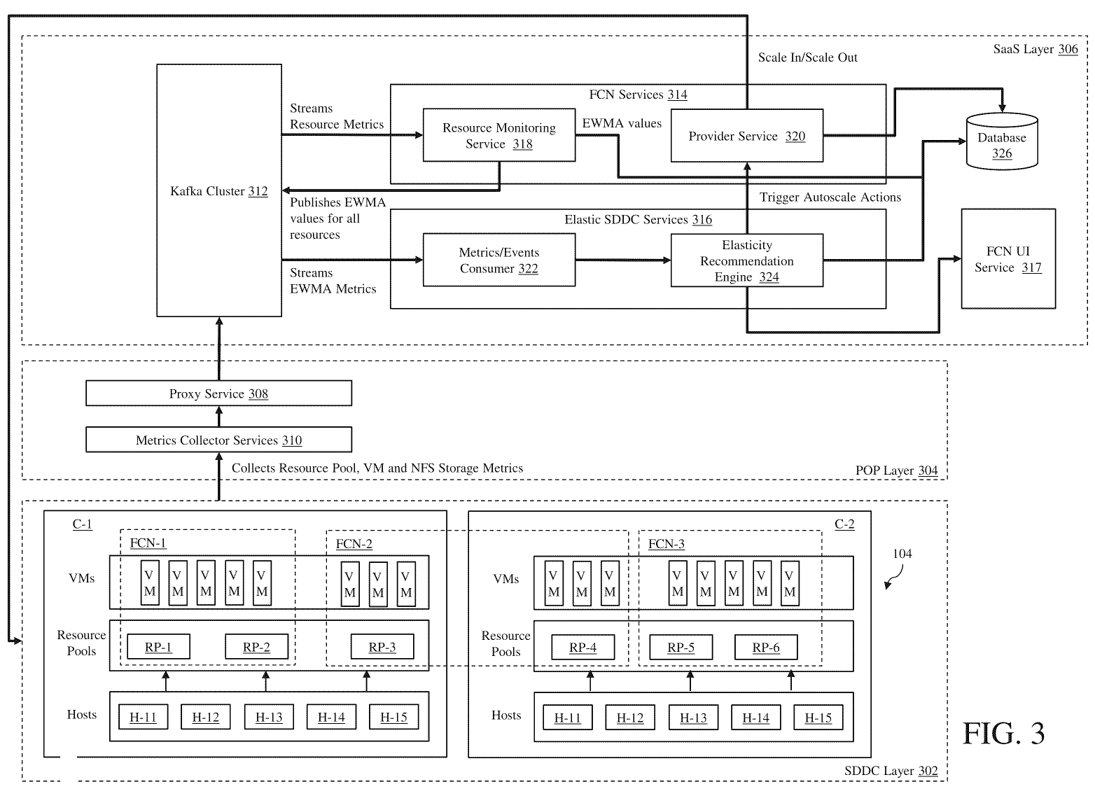

Turning now to FIG. 3, components and elements of the computing system 100, which are involved in the FCN autoscaling operations, are illustrated as layers in accordance with an embodiment of the invention. Thus, some of these components can be viewed as being components of the FCN autoscaling system 160. As shown in FIG. 3, the layers in the computing system 100 that are involved in the FCN autoscaling operations include an SDDC layer 302, a POP layer 304 and a SaaS layer 306. The SDDC layer 302 consists of the SDDC 104, which contains multiple clusters C-1 . . . . C-m, where each cluster containing multiple hosts H-1 . . . . H-n. The number of clusters in the SDDC 104 and the number of hosts in each of the clusters can vary. Resource pools are created using the host capacity based on the requirements provided by the customers while creating an FCN. Each resource pool contains VMs deployed by customers in the FCN. In the illustrated example, the SDDC 104 supports flexible cloud namespaces FCN-1, FCN-2 and FCN-3. The flexible cloud namespace FCN-1 includes resource pools RP-1 and RP-2, which contain five (5) VMs. The resource pools RP-1 and RP-2 are created using the host capacity in the cluster C-1. The flexible cloud namespace FCN-2 includes resource pools RP-3 and RP-4, which contain six (6) VMs. As illustrated, the resource pool RP-3 is created using the host capacity in the cluster C-1, while the resource pool RP-4 is created using the host capacity in the cluster C-2. The flexible cloud namespace FCN-3 includes resource pools RP-5 and RP-6, which contain five (5) VMs. The resource pool RP-5 and RP-6 are created using the host capacity in the cluster C-2.

The POP layer 304 includes a POP proxy 308 and multiple metrics collector services 310 that collect different metrics from the SDDC 104 for all resources consumed in the SDDC 104. The metrics collector services 310 collect different types of consumption metrics for resources, such as CPU, memory, network for VMs, and resource pools in the SDDC. In an embodiment, network file system (NFS) servers are used for storage, which can collect metrics for datastore usage and free capacity. All these metrics are then pushed or published into a high-volume Apache Kafka® cluster 312 on dedicated topics in the SaaS layer 306 via the POP proxy 308. In an embodiment, the POP proxy 308 and the metrics collector services 310 reside in the POP device 150 in the SDDC 104.

The SaaS layer 306 consists of all the SaaS services, which include the high-volume Apache Kafka cluster 312, FCN services 314, elastic SDDC services 316 and a user interface (UI) service 317. The FCN services 314 include a resource monitoring service 318 and a provider service 320. The elastic SDDC services 316 include a metrics/events consumer 322 and an elasticity recommendation engine 324. These components of the FCN services 314 and the elastic SDDC services 316 are described below.

The Kafka cluster 312 is a distributed event store and stream-processing system that consists of many brokers, topics, and partitions. The key objective of the Kafka cluster 312 is to distribute workloads equally among replicas and partitions. In an embodiment, dedicated topics are created in the Kafka cluster that are used by different services. All the collector services publish the metrics into their respective topics in the Kafka cluster. The resource monitoring service 318 of the FCN services 314 and the metrics/events consumer 322 of the elastic SDDC services 316 subscribe to the required topics and consume the metrics or events.

The resource monitoring service 318 of the FCN services 314 consumes the metrics published by the different collector services 310, and calculates elastic weighted moving average (EWMA) values for each resource usage, which is stored in a database 326. The database 326 is used to store various data for the FCN autoscaling operations. The resource monitoring service then creates a metric/event for the resource usage with additional details, such as an FCN identifier and a CP identifier. These enriched metrics are then published into the Kafka cluster 312 for consumption for the elastic SDDC services 316.

The provider service 320 of the FCN services 314 is the main service that exposes application programming interfaces (APIs) and workflows for major FCN and VM operations and interacts with the database 326. Upon receiving a scale-out or scale-in recommendation from the elastic SDDC services 316, the provider service 320 then triggers a workflow to actually scale out or scale in the resources in the SDDC 104.

The metrics/events consumer 322 of the elastic SDDC services 316 subscribes to the appropriate topic of the Kafka cluster 312 and continuously receives streaming metrics from the topic, where the resource monitoring service 318 publishes the enriched metrics. Then, the enriched metrics are pushed into the elasticity recommendation engine 324 of the elastic SDDC services 316 for further processing. These metrics are then filtered, validated and throttled by the elasticity recommendation engine 324, if necessary.

The elasticity recommendation engine 324 of the elastic SDDC services 316 processes these metrics, fetches the corresponding elasticity policy for the CP and then uses an algorithm to make a decision and generate a recommendation, i.e., a scale-out or scale-in recommendation. The recommendation is then sent to the provider service 320, which scales out or scales in the actual resources in the SDDC 104.

The FCN UI service 317 is used by the customers to set and configure their FCN elasticity policies. The elastic SDDC services 316 store these policies in the database 326 and use these policies for elasticity recommendations. Various components of the SDDC layer 302, the POP layer 304 and the SaaS layer 306 that are involved in the autoscaling operation can be viewed as the elements that make up the FCN autoscaling system 160.

The process of making autoscaling recommendation by the FCN autoscaling system 160 is further described. To monitor the resource consumption for elasticity, the metrics collector services 310 in the POP layer 304 and the resource monitoring service 318 in the SaaS layer 306 are used. For FCNs, the resource monitoring service 318 monitors the consumption of all resources in a CP under each FCN. These metrics are collected by the metrics collector services 310, and, in a particular embodiment, pushed into the Kafka cluster 312 via an API proxy gateway used for forwarding resource metrics from the SDDC 104 to the Kafka cluster.

The resource pool metrics, which are collected by a number of counters, are VM consumption metrics aggregated at the CP level of an FCN. In an embodiment, these collectors may use counters that may be already available in the SDDC 104, such as VMware vSphere® counters. Below is a list of counters that may be used in FCN elasticity.
1. CPU counter-cpu.usagemhz.average.rate.megaHertz. This counter denotes the amount of actively used virtual CPU. This counter corresponds to active CPU consumption at the resource pool level.
2. Memory counters-mem.consumed.average.absolute.kiloBytes and mem.swapped.average.absolute.kiloBytes). The mem.consumed.average.absolute.kiloBytes counter denotes the amount of actively consumed memory and overhead memory for all the VMs aggregated at the resource pool. The mem.consumed.average.absolute.kiloBytes counter corresponds to actively consumed memory plus memory overhead at the resource pool level. In an embodiment, in order to align with an existing resource allocating algorithm (memory local demand=VM memory consumed+memory overhead+memory swap aggregated from all hosts in cluster), e.g., VMware elastic Distributed Resource Scheduler (EDRS) algorithm, the counter of memory swap at the resource pool level, i.e., mem.swapped.average.absolute.kiloBytes, is included to derive the memory EWMA memory demand at the capacity profile level.

For storage, in an embodiment, network file system (NFS) consumption metrics of free_space and capacity are used to compute consumption of the NFS datastore that represents the storage profile. Since FCN storage CPs will constitute NFS datastores, the following formula can be used to calculate storage consumption:

$$Utilization percentage E = ( capacity - free\_space ) / capacity * 100$$

The metrics collector services 310 periodically collect the capacity and free space metrics from the SDDC 104.

The resource monitoring service 318 of the FCN services 314 consumes the output of the above counters and generates scale-in and scale-out EWMA values for CPU, memory and storage resources for all the capacity profiles using the following equations:

$$Scale - in - EWMA = ( 1 - scale - in - weight ) * scale - in - EWMA + scale - in - weight * resource - current - demand ; and \\ Scale - out - EWMA = ( 1 - scale - out - weight ) * scale - out - EWMA + scale - out - weight * resource - current - demand$$

Here, the scale-in weight can be a fixed number, e.g., 0.3, so that recommendations are provided based on a smoothened resource consumption pattern instead of reacting on spikes.

Once these EWMA values are generated, the resource monitoring service 318 then correlates the metrics with the corresponding CP and FCN from the database 326. The resource monitoring service then pushes all the information (i.e., resource type, EWMA, CP identifier and FCN identifier) to the respective topics in the Kafka cluster 312 to be consumed by the elastic SDDC services 316. The elasticity recommendation engine 324 in the elastic SDDC services 316 validates these metrics against different thresholds set by the customers as part of the elasticity policy and makes scale-out/scale-in recommendations for the customers. The recommendation from the elasticity recommendation engine is passed on to the provider service 320, which invokes the workflow to scale out or scale in resources in the SDDC 104 as per the recommendation.

As an example, let's assume that a general-purpose capacity profile has been requested and current consumptions for CPU, memory, storage are 65%, 45%, and 53%, respectively. In this scenario, the resource monitoring service 318 will stream the CPU and memory consumption metrics and storage (e.g., NFS) metrics from the Kafka cluster 312. Assuming a EWMA weight of 0.3 is defined for all three resources, scale-out EWMA will be calculated using the following formula:

$$Scale - out - EWMA - resource = ( 1 - scale - out - weight ) * scale - out - EWMA + scale - out - weight * resource - current - demand$$

EWMA calculation for the three resources will be calculated and persisted in data fabric by the resource monitoring service 318 per CP as:

$$Scale - out - EWMA - CPU = ( 1 - 0.3 ) * 65 + 0.3 * 65 = 65 \\ Scale - out - EWMA - MEM = ( 1 - 0.3 ) * 45 + 0.3 * 45 = 45 \\ Scale - out - EWMA - STORAGE = ( 1 - 0.3 ) * 53 + 0.3 * 53 = 53$$

Let's say, in next five (5) mins, the consumptions for CPU, memory and storage are as follows: 80%, 48% and 50% respectively (increase in CPU consumption). Then, EWMA values are calculated as follows:

$$Scale - out - EWMA - CPU = ( 1 - 0.3 ) * 65 + 0.3 * 80 = 70 \\ Scale - out - EWMA - MEM = ( 1 - 0.3 ) * 45 + 0.3 * 48 = 46 \\ Scale - out - EWMA - STORAGE = ( 1 - 0.3 ) * 53 + 0.3 * 50 = 52$$

Again, the latest EWMA values will be persisted. The resource monitoring service 318 will only persist one EWMA metric per CP and push the value down to the elastic SDDC services 316 via the Kafka cluster 312.

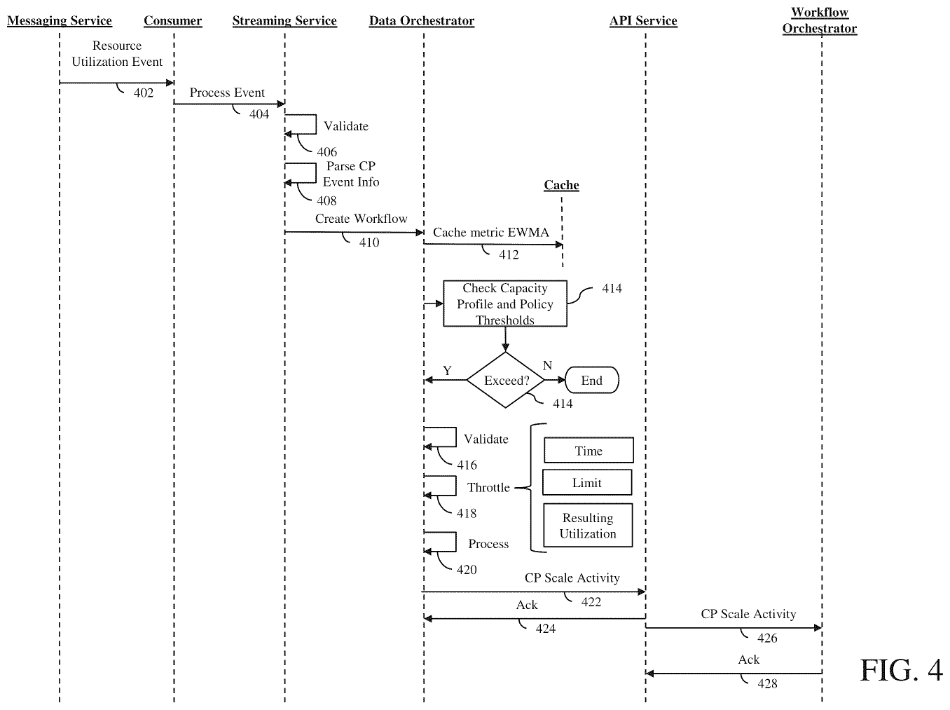

A process of automatically scaling an FCN in the SDDC 104 in accordance with an embodiment of the invention is described with reference to a flow diagram of FIG. 4. As illustrated in step 402, a resource utilization event is published by a messaging service (i.e., the proxy service 308 and the metrics collector services 310 in the POP layer 304 and the Kafka cluster 312). The published resource utilization event is then processed by a consumer (i.e., the resource monitoring service 318) and transmitted to a streaming service (i.e., the Kafka cluster 312), as illustrated in step 404. The processed event is then validated and CP event information is parsed by the streaming service, as illustrated in steps 406 and 408. In an embodiment, the validation may be done with respect to (1) freshness/staleness, (2) duplicity of the event and (3) state of the FCN.

Next, an instruction to create a workflow is transmitted to the data orchestrator (i.e., the elasticity recommendation engine 324), as illustrated in step 410. As part of the workflow, EWMA metric is stored in the cache (e.g., the database 326) by the data orchestrator, as illustrated in step 412. Next, at step 414, the CP and policy thresholds are checked by the data orchestrator. The EWMA metric is then compared with CP and policy thresholds by the data orchestrator, as illustrated in step 416. If the EWMA metric does not exceed any threshold, then the process comes to an end.

However, If the EWMA metric does exceed any threshold, then the process proceeds to step 416, where the results of the comparison are validated by the data orchestrator, which may be similar to the previous validation process. Next, at step 418, the autoscaling parameters are throttled with respect to time, limit and resulting utilization, by the data orchestrator, if necessary. Next, at step 420, the metrics are processed by the data orchestrator to determine if a scale-in or scale-out operation needs to be performed.

Based on the processed data, an instruction to autoscale the CP is transmitted to an API service (i.e., the provider service 320) from the data orchestrator, as illustrated in step 422. An acknowledgement to the autoscale CP instruction is then transmitted back to the data orchestrator by the API service, as illustrated in step 424. In response to the autoscale CP instruction, a CP scale activity request is made to a workflow orchestrator (not shown but can be a service running in the FCN services 314) by the API service, as illustrated in step 426. An acknowledgement to the CP scale activity request is then transmitted back to the API service by the workflow orchestrator, as illustrated in step 428.

Different policy types for the FCN autoscaling system are now described. These policy types include a consumption based policy, a reservation based policy, a schedule based policy and a rapid/burst based policy. However, the FCN autoscaling system may handle other types of policies.

A policy based on consumption data closely tracks the weighted average to decide scaling actions. A policy could be configured so as to ignore the changes in compute consumption but be sensitive towards memory consumption. For example, in workload applications that are caching servers, the compute usage would be fairly stable and then one may not want to react on changes happening in compute utilization, but one is concerned about increased memory utilization as that directly affects the caching application's ability to store data in memory. In such a case, as an example, a consumption-based policy can be configured as follows:
maxCpuThreshold—200
minCpuThreshold—0
maxMemoryThreshold—80
minMemoryThreshold—0
scaleIncrement—1
maxLimit—10
minLimit—2

In the above policy example, the scaling never takes place for compute but does so for increase in memory utilization. Again, there is never a scale in either due to compute or memory as these resources are set to a very low threshold that cannot be met. However, scale out will occur to add more resources to the FCN CP so that the FCN has higher memory available.

A similar case is true for database servers. Here, compute and memory take less of a precedence, but the storage utilization metrics take a higher one. In such a case, scaling due to both compute and memory may be disabled or set to threshold values that cannot be met. But for storage threshold, there can be thresholds where the storage capacity is scaled when these thresholds are met. As an example, such a policy configuration could look like following:

Compute and Memory capacity profiles:
maxCpuThreshold—200
minCpuThreshold—0
maxMemoryThreshold—200
minMemoryThreshold—0
scaleIncrement—1
maxLimit—10
minLimit—2

Storage capacity profiles:
maxStorageThreshold—80
minStorageThreshold—60
scaleIncrement—1
maxLimit—10
minLimit—2

A second different type of elasticity that could be rendered to an FCN can be based out of resource reservation that are required to power on and run a workload VM. Reservations are minimum resource guarantees that are provided to a workload VM when it is running. These reservations are not the actual resource usages of the VM. The actual resources used by the VM could be either greater or less than the set or configured reservations. However, a reservation tries to make available the requested resources to a VM. If the reservations allotted to the VMs that are part of the FCN exceed the total capacity of the resources available at the FCN, then that could lead to a problem when all such VMs are turned on and set to run. Since the reservations are guaranteed during a VM run, users can maintain a large number of powered off VMs in the FCN without new resources being added. Resources would be added and removed in response to VM power off or on. An elastic policy could help by scaling the resources of an FCN and its CP by tracking the total reservation made in the FCN and the running status of the VMs. If these far exceed the resources available, then scaling up of the FCN can be undertaken. A value for the threshold could be arrived at empirically and could be set to 100% or 120% of the total capacity of the FCN. Similarly, a scaling down of the FCN resources can be performed if workload VMs with reserved resources are removed.

A third different type of elasticity that could be rendered to an FCN can be based on schedules. There are certain applications that see cyclic increase and decrease of utilization during particular times of day, week, month or season. For these applications, always allocating the peak resource capacity is wasteful and results in non-optimal utilization of an FCN resource pool. To address such cases, a policy that follows a particular set schedule, which is configured when the policy is created or which can be changed otherwise, to scale in and scale out resource capacity could help in increasing the optimum use of the resources, thereby also saving the extra costs associated with non-optimal utilization. These policies behave as a cron job that do the scaling up and scaling down of the resources as per the schedule. This is done irrespective of the resource utilization metrics.

A fourth different type of elasticity that could be rendered to an FCN can be based on burst of resource usage. There are use cases that tend to see increased usage only for a short duration or time. For example, flash sale in an e-commerce website, student registrations during start of an academic year, and certain kinds of migration or upgrades experience significant increase in resource usage for short periods of time. This increased usage does not last a long time, and therefore, in such cases, it becomes costly and inefficient to make a permanent or long-lived increase in resource capacities. These use cases may be seeing stable resource utilization levels for most of the time in their lifecycle. However, when the additional capacity is needed, the resources are needed in a far larger size and in a much shorter time. In such cases, relying on incremental increase in capacity would not help in serving these workloads better. That is where burst policies come into play and expand the capacity disproportionally, albeit either based on a resource utilization metrics or for a fixed amount of time.

Different use cases for the FCN autoscaling system are now described. These policy types include capacity balancing, burst capacity, support for large number of VMS and disaster recovery. However, the FCN autoscaling system may handle many other types of use cases.

With respect to capacity balancing, let's say assume a customer has purchased capacity for following three (3) capacity profiles: two (2) general purpose capacity profiles GP-1 and GP-2, and one (1) memory optimized capacity profile to deploy their workloads via subscription. There can be a situation where the customer has run out of capacity in GP-1 and has half capacity available in GP-2. In this case, if GP-1 is scaled out, the customer will have to pay extra for the additional on-demand capacity added for the scale out in spite of having capacity available in another capacity profile. So, the FCN autoscaling system may be configured to balance the resources in the capacity profiles if a customer has run out of capacity in one capacity profile and has enough capacity in another capacity profile.

There are two ways to achieve this balancing of capacity profiles. The first way is to move workloads across capacity profiles or use capacity from available capacity profiles to balance the resource consumption and avoid unnecessary scale-outs, thereby making it a cost-efficient solution for the customers. The customers will not be affected by the rebalancing as the workloads need not be reconfigured or power cycled while moving to another capacity profile. The second way is to move FCN units between capacity profiles. For example, if one capacity profile, e.g., GP-1, has reached capacity and other capacity profile, e.g., GP-2, has enough free capacity or FCN units, FCN units can be moved from the latter capacity profile with free capacity to the former capacity profile (GP-2 to GP-1) to balance the load. This can balance the resource consumption on the capacity profiles and avoid scale-outs.

An algorithm executed by the FCN autoscaling system for capacity balancing in accordance with an embodiment of the invention is now described. The algorithm will calculate and determine the best solution for capacity balancing (using one or both of the capacity balancing ways) based on the type and size of workloads and resource consumption. The algorithm will then make sure moving capacity or workloads does not increase the resource consumption of the capacity profile (e.g., GP-2) beyond a safe threshold to avoid ping-pong effect.

With respect to burst capacity, let's say a shopping store company wants to deploy their application on FCNs. Let's assume that the shopping store company needs ten (10) general purpose FCNs per year to support their application across all the locations in the United States. Almost all the people shop for gifts and many other things during big holidays, such as Thanksgiving and Christmas. The load on the application at such times can easily be ten (10) times as that of the usual load. To support the high load or demand for a few days in a year, it is not feasible for the shopping store company to purchase more capacity than needed for the entire year using a subscription. This will be very expensive to the shopping store company. Here, the FCN autoscaling system helps in cutting down the additional cost by a significant number. The FCN autoscaling system will monitor the resource consumption and grow the FCNs as needed automatically during such holidays to cater to the increasing load. As soon, as the load/demand goes down after the holidays, the CFN autoscaling system will shrink the FCNs. Hence, the shopping store company will use on-demand capacity only for a few days when the load is high, and the additional cost will still be significantly less compared to buying additional capacity in subscription for the entire year.

With respect to support for large number of VMs, let's assume a customer wants to deploy a large number of VMs and keep them in powered-off state until needed. For this use case, the customer need not buy the capacity to run all the VMs using subscription as many of VMs can be in powered-off state. The customer can purchase the minimum capacity required for their frequently running VMs. The above elasticity solution can help add or remove capacity to scale out or scale in their FCNs based on the reservation resources required to power on VMs when needed.

This capability has two advantages. First, customers can purchase only the minimum required capacity. Additional capacity added to power on VMs will be charged on-demand only for the time period when the VMs are in use. As the demand goes down, the FCN will be scaled in making it cost efficient. Second, customers need not delete their VMs and redeploy them when needed due to capacity restrictions. The customers can simply power off their VMs when not in use. In this way, the customers can maintain a large number of VMs without buying capacity for all of them.

With respect to disaster recovery, let's assume a customer has an on-premise data center and the customer has deployed a small FCN for a disaster/recovery pod. In case of any disaster, their critical workloads in the data center can utilize the capacity from the FCN. The frequency of disasters is usually pretty low. So, as a backup, it is highly expensive for the customers to buy huge capacity upfront. Now, when an actual disaster occurs and the data center workloads start consuming capacity on the FCN, it might be possible that the capacity available in the FCN might not be enough for all the workloads. Here, the FCN autoscaling system will help the customer grow their FCN temporarily to accommodate all the critical workloads till their on-premise data center recovers and resources are available. So, the customer will only be charged additional for the on-demand capacity used during the disaster. In an embodiment, this can be achieved by integrating the FCN autoscaling system with an existing disaster recovery solution, such as VMware Cloud Disaster Recovery service.

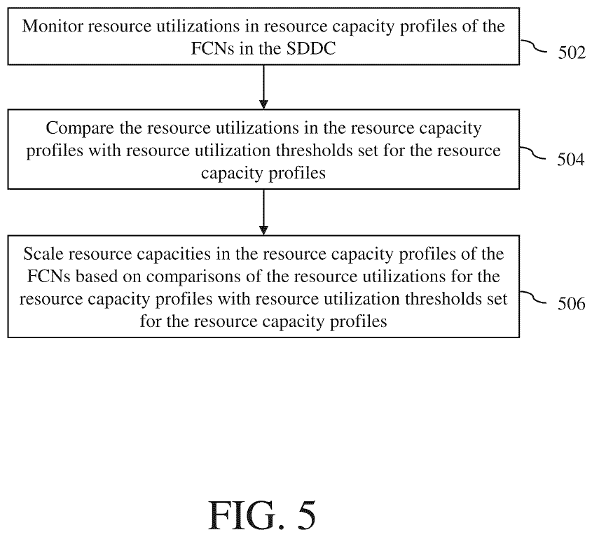

A computer-implemented method for scaling flexible cloud namespaces (FCNs) in a software-defined data center (SDDC) in accordance with an embodiment of the invention is described with reference to a flow diagram of FIG. 5. At block 502, resource utilizations in resource capacity profiles of the FCNs in the SDDC are monitored. At block 504, the resource utilizations in the resource capacity profiles are compared with resource utilization thresholds set for the resource capacity profiles. At block 506, resource capacities in the resource capacity profiles of the FCNs are scaled based on comparisons of the resource utilizations for the resource capacity profiles with resource utilization thresholds set for the resource capacity profiles.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

1. A computer-implemented method for scaling flexible cloud namespaces (FCNs) in a software-defined data center (SDDC), the method comprising:
monitoring resource utilizations in resource capacity profiles of the FCNs in the SDDC;
comparing the resource utilizations in the resource capacity profiles with resource utilization thresholds set for the resource capacity profiles; and
scaling resource capacities in the resource capacity profiles of the FCNs based on comparisons of the resource utilizations for the resource capacity profiles with resource utilization thresholds set for the resource capacity profiles.

2. The computer-implemented method of claim 1, wherein the resource capacity profiles of the FCNs include compute capacity profiles and storage capacity profiles.

3. The computer-implemented method of claim 1, wherein monitoring the resource utilizations includes monitoring the resource utilizations in the resource capacity profiles of the FCNs using CPU and memory counters in the SDDC.

4. The computer-implemented method of claim 1, further comprising employing a stream processing platform with brokers and consumers to process messages related to the resource utilizations in the SDDC.

5. The computer-implemented method of claim 4, further comprising calculating elastic weighted moving average (EWMA) values for the resource utilizations in the resource capacity profiles of the FCNs.

6. The computer-implemented method of claim 5, wherein the EWMA values for each resource are calculated using:
Scale-in-EWMA=(1−scale-in-weight)*scale-in-EWMA+scale-in-weight*resource-current-demand; and
Scale-out-EWMA=(1-scale-out-weight)*scale-out-EWMA+scale-out-weight*resource-current-demand,
where scale-in-weight and scale-out-weight are fixed values, scale-in-EWMA and scale-out-EWMA are previously EWMA values, and resource-current-demand is a current resource utilization.

7. The computer-implemented method of claim 5, further comprising:
publishing the EWMA values along with capacity profile identifiers and flexible cloud namespace identifiers to the stream processing platform; and
generating scaling recommendations based on the published EWMA values.

8. The computer-implemented method of claim 1, wherein scaling the resource capacities in the resource capacity profiles of the FCNs includes scaling the resource capacities in the resource capacity profiles of the FCNs in terms of FCN units, wherein each FCN unit includes specified amount of resources.

9. The computer-implemented method of claim 1, wherein each of the FCNs includes a plurality of virtual machines.

10. A non-transitory computer-readable storage medium containing program instructions for scaling flexible cloud namespaces (FCNs) in a software-defined data center (SDDC), wherein execution of the program instructions by one or more processors causes the one or more processors to perform steps comprising:
monitoring resource utilizations in resource capacity profiles of the FCNs in the SDDC;
comparing the resource utilizations in the resource capacity profiles with resource utilization thresholds set for the resource capacity profiles; and
scaling resource capacities in the resource capacity profiles of the FCNs based on comparisons of the resource utilizations for the resource capacity profiles with resource utilization thresholds set for the resource capacity profiles.

11. The non-transitory computer-readable storage medium of claim 10, wherein the resource capacity profiles of the FCNs include compute capacity profiles and storage capacity profiles.

12. The non-transitory computer-readable storage medium of claim 10, wherein monitoring the resource utilizations includes monitoring the resource utilizations in the resource capacity profiles of the FCNs using CPU and memory counters in the SDDC.

13. The non-transitory computer-readable storage medium of claim 10, wherein the steps further comprise employing a stream processing platform with brokers and consumers to process messages related to the resource utilizations in the SDDC.

14. The non-transitory computer-readable storage medium of claim 13, wherein the steps further comprise calculating elastic weighted moving average (EWMA) values for the resource utilizations in the resource capacity profiles of the FCNs.

15. The non-transitory computer-readable storage medium of claim 14, wherein the EWMA values for each resource are calculated using:
$$Scale - in - EWMA = ( 1 - scale - in - weight ) * scale - in - EWMA + scale - in - weight * resource - current - demand ; and \\ Scale - out - EWMA = ( 1 - scale - out - weight ) * scale - out - EWMA + scale - out - weight * resource - current - demand ,$$
where scale-in-weight and scale-out-weight are fixed values, scale-in-EWMA and scale-out-EWMA are previously EWMA values, and resource-current-demand is a current resource utilization.

16. The non-transitory computer-readable storage medium of claim 14, wherein the steps further comprise:
publishing the EWMA values along with capacity profile identifiers and flexible cloud namespace identifiers to the stream processing platform; and
generating scaling recommendations based on the published EWMA values.

17. The non-transitory computer-readable storage medium of claim 10, wherein scaling the resource capacities in the resource capacity profiles of the FCNs includes scaling the resource capacities in the resource capacity profiles of the FCNs in terms of FCN units, wherein each FCN unit includes specified amount of resources.

18. The non-transitory computer-readable storage medium of claim 10, wherein each of the FCNs includes a plurality of virtual machines.

19. A computer system comprising:
memory; and
at least one processor configured to:
monitor resource utilizations in resource capacity profiles of flexible cloud namespaces (FCNs) in a software-defined data center (SDDC);
compare the resource utilizations in the resource capacity profiles with resource utilization thresholds set for the resource capacity profiles; and
scale resource capacities in the resource capacity profiles of the FCNs based on comparisons of the resource utilizations for the resource capacity profiles with resource utilization thresholds set for the resource capacity profiles.

20. The computer system of claim 19, wherein the at least one processor is configured to:
calculate elastic weighted moving average (EWMA) values for the resource utilizations in the resource capacity profiles of the FCNs;
publish the EWMA values along with capacity profile identifiers and flexible cloud namespace identifiers to a stream processing platform; and
generate scaling recommendations based on the published EWMA values.
